(19) United States
(12) Patent Application Publication
(10) Pub. No.: US 2026/0351942 A1
(43) Pub. Date: Nov. 5, 2026

(54) COPPER-ALUMINUM BUSBAR WITH INTERLOCK INTERFACE

(71) Applicant: GM Global Technology Operations LLC, Detroit, MI (US)

(72) Inventors: Zhou Wang, Shanghai (CN); Bradley Allen Newcomb, Troy, MI (US); Jiachen Pang, Shanghai (CN); Jianfeng Wang, Shanghai (CN); Xiaosong Huang, Novi, MI (US)

(21) Appl. No.: 19/202,351

(22) Filed: May 8, 2025

(30) Foreign Application Priority Data
Apr. 30, 2025 (CN) 2025105713022

(51) Int. Cl. H02G 5/02; H01F 27/28

(52) U.S. Cl. CPC H02G 5/02; H01F 27/28

(57) ABSTRACT

A busbar with an interlock interface includes an aluminum (Al) body. The Al body includes an upper surface and a lower surface opposing the upper surface. The busbar further includes a first copper (Cu) coil embedded within the Al body. The first Cu coil includes a first outer surface flush with the upper surface of the Al body. The first Cu coil further includes a first inner surface opposing the first outer surface. The first Cu coil further includes a first set of side surfaces positioned between and connected to the first outer surface and the first inner surface. The first Cu coil further includes a first edge formed by the connection of the first set of side surfaces and the first inner surface. The first edge defines a first angle between 20 and 70 degrees.

The present disclosure relates to a busbar for a vehicle. More particularly, the invention relates to a copper-aluminum (Cu-Al) busbar with an interlock interface for a vehicle.

Electric and hybrid electric vehicle technology has been enabled by the development and deployment of rechargeable, secondary batteries. The secondary batteries provide energy to electric traction motors, servo motors, and other electronics in the vehicle. Busbars are used to establish switching connections between windings in the motors and connect the windings to phase connectors, which are connected to power electronics. Busbars may be fabricated in a variety of shapes and are commonly formed of Cu or Al. The material composition determines the maximum carriable current. The busbar may also be formed of both Cu and Al, creating a mass reduction of the secondary batteries. However, interface reliability may be an issue with Cu-Al busbars. While Cu-Al busbars undergo working conditions, the Cu-Al busbars will experience cyclic electric and thermal loading, mechanical vibration, and corrosion.

Thus, while present Cu-Al busbars achieve their intended purpose, there is a need for new and improved design to improve the reliability of the Cu-Al busbar during working conditions.

### SUMMARY

According to several aspects, a busbar with an interlock interface is provided. The busbar includes an aluminum (Al) body. The Al body includes an upper surface and a lower surface opposing the upper surface. The busbar further includes a first copper (Cu) coil embedded within the Al body. The first Cu coil includes a first outer surface flush with the upper surface of the Al body. The first Cu coil further includes a first inner surface opposing the first outer surface. The first Cu coil further includes a first set of side surfaces positioned between and connected to the first outer surface and the first inner surface. The first Cu coil further includes a first edge formed by the connection of the first set of side surfaces and the first inner surface. The first edge defines a first angle between 20 and 70 degrees.

In an additional aspect of the present disclosure, the first edge is tapered.

In another aspect of the present disclosure, at least a portion of a perimeter of the first Cu coil is coated with one of the following: tin (Sn), nickel (Ni), and silver (Ag).

In another aspect of the present disclosure, the first set of side surfaces defines a first width increasing from the first inner surface towards the first outer surface.

In another aspect of the present disclosure, the first set of side surfaces defines a first width decreasing from the first inner surface towards the first outer surface.

In another aspect of the present disclosure, the busbar further including a second Cu coil embedded within the Al body. The second Cu coil includes a second outer surface flush with the lower surface of the Al body. The second Cu coil further includes a second inner surface opposing the second outer surface. The second Cu coil further includes a second set of side surfaces positioned between and connected to the second outer surface and the second inner surface. The second set of side surfaces defines a second width decreasing from the second inner surface towards the second outer surface. The second Cu coil further includes a second edge formed by the connection of the second set of side surfaces and the second inner surface. The second edge defines a second angle between 20 and 70 degrees.

In another aspect of the present disclosure, the first edge of the first Cu coil and the second edge of the second Cu coil are tapered.

In another aspect of the present disclosure, the busbar further includes a middle Cu portion. The middle Cu portion is positioned between the first Cu coil and the second Cu coil, connecting the first Cu coil to the second Cu coil.

According to several aspects, a method of forming a busbar is provided. The method includes heating aluminum (Al) to form liquid Al. The method further includes channeling the liquid Al to water cooled rollers. The method further includes feeding a first copper (Cu) coil between the water cooled rollers. The first Cu coil is in contact with an upper surface of the liquid Al. The water cooled rollers apply pressure against the first Cu coil and the liquid Al. The pressure embeds the first Cu coil within the liquid Al. The method further includes cooling the liquid Al with the water cooled rollers, solidifying the liquid Al and bonding the first Cu coil to the solid Al. The method further includes creating a tensioned coil with the solid Al and the first Cu coil, forming the busbar.

In another aspect of the present disclosure, the method further includes cutting the first Cu coil to a first desired shape prior to feeding the first Cu coil between the water cooled rollers. The first desired shape includes a first outer surface flush with an upper surface of the Al. The first desired shape further includes a first inner surface opposing the first outer surface. The first desired shape further includes a first set of side surfaces. The first set of side surfaces defines a first angle. The first angle is between 20 and 70 degrees.

In another aspect of the present disclosure, the first desired shape defines a first width increasing from the first inner surface towards the first outer surface.

In another aspect of the present disclosure, the first desired shape defines a first width decreasing from the first inner surface towards the first outer surface.

In another aspect of the present disclosure, the method further includes cutting a second Cu coil to a second desired shape. The second desired shape includes a second outer surface flush with a lower surface of the Al. The second desired shape further includes a second inner surface opposing the second outer surface. The second desired shape further includes a second set of side surfaces. The second set of side surfaces defines a second angle. The second angle is between 20 and 70 degrees. The method further includes feeding the cut second Cu coil between the water cooled rollers. The cut second Cu coil is in contact with a lower surface of the liquid Al. The water cooled rollers apply pressure against the cut second Cu coil and the liquid Al. The pressure embeds the cut second Cu coil within the liquid Al. The water cooled rollers solidify the liquid Al, bonding the cut second Cu coil to the solid Al.

In another aspect of the present disclosure, the first desired shape defines a first width decreasing from the first inner surface towards the first outer surface. The second desired shape defines a second width decreasing from the second inner surface towards the second outer surface.

In another aspect of the present disclosure, the first Cu coil is a plurality of pultruded copper.

In another aspect of the present disclosure, the plurality of pultruded copper is hollow.

According to several aspects, a method of forming a busbar is provided. The method includes heating aluminum (Al) to form liquid Al. The method further includes channeling the liquid Al to water cooled rollers. The method further includes cutting a first copper (Cu) coil to a first desired shape. The first desired shape includes a first outer surface, a first inner surface, and a first set of side surfaces. The first set of side surfaces defines a first angle. The first angle is between 20 and 70 degrees. The method further includes feeding the cut first Cu coil between the water cooled rollers. The cut first Cu coil is in contact with an upper surface of the liquid Al. The water cooled rollers apply pressure against the cut first Cu coil and the liquid Al. The pressure embeds the cut first Cu coil within the liquid Al. The method further includes cooling the liquid Al with the water cooled rollers, solidifying the liquid Al and bonding the cut first Cu coil to the solid Al. The method further includes creating a tensioned coil with the solid Al and the cut first Cu coil, forming the busbar.

In another aspect of the present disclosure, the first desired shape defines a first width increasing from the first inner surface towards the first outer surface.

In another aspect of the present disclosure, the first desired shape defines a first width decreasing from the first inner surface towards the first outer surface.

In another aspect of the present disclosure, the method further includes cutting a second Cu coil to a second desired shape. The second desired shape includes a second outer surface flush with a lower surface of the Al. The second desired shape further includes a second inner surface opposing the second outer surface. The second desired shape further includes a second set of side surfaces. The second set of side surfaces defines a second angle between 20 and 70 degrees. The second desired shape defines a second width decreasing from the second inner surface towards the second outer surface. The method further includes feeding the cut second Cu coil between the water cooled rollers. The cut second Cu coil is in contact with a lower surface of the liquid Al. The water cooled rollers apply pressure against the cut second Cu coil and the liquid Al. The pressure embeds the cut second Cu coil within the liquid Al. The water cooled rollers solidify the liquid Al, bonding the cut second Cu coil to the solid Al.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a perspective view of a plurality of busbars within a vehicle according to an exemplary embodiment.

FIG. 1B is an enlarged view of the plurality of busbars connected to a plurality of battery cells.

FIG. 2A is a cross-section view of the busbar according to an exemplary embodiment.

FIG. 2B is a cross-section view of an alternate busbar according to an exemplary embodiment.

FIG. 2C is a cross-section view of another alternate busbar according to an exemplary embodiment.

FIG. 2D is a cross-section view of yet another alternate busbar according to an exemplary embodiment.

FIG. 3 is an enlarged cross-section view of a tapered edge of the busbar according to an exemplary embodiment.

FIG. 4A is an enlarged cross-section view of a coating covering a portion of the busbar according to an exemplary embodiment.

FIG. 4B is an enlarged cross-section view of a coating covering an alternate portion of the busbar according to an exemplary embodiment.

FIG. 5A is a cross-section view of the busbar with a copper wire according to an exemplary embodiment.

FIG. 5B is a cross-section view of the busbar with an alternate copper wire according to an exemplary embodiment.

FIG. 6 is a side view of twin roll casting to create the busbar according to an exemplary embodiment.

FIG. 7 is a side view of an alternate twin roll casting to create the busbar according to an exemplary embodiment.

FIG. 8 is a method for creating the busbar according to an exemplary embodiment.

FIG. 9 is an alternate method for creating the busbar according to an exemplary embodiment.

### DETAILED DESCRIPTION

The following description is merely exemplary in nature and is not intended to limit the present disclosure, application, or uses.

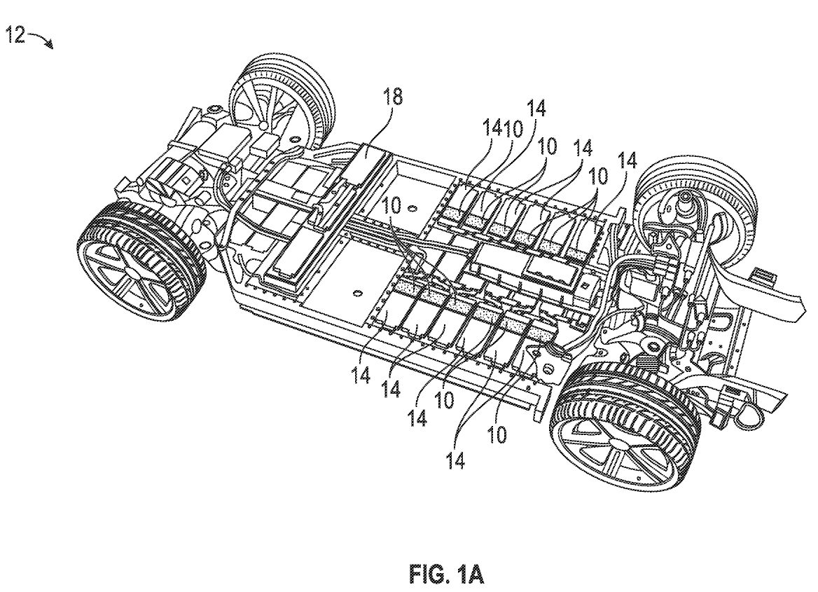

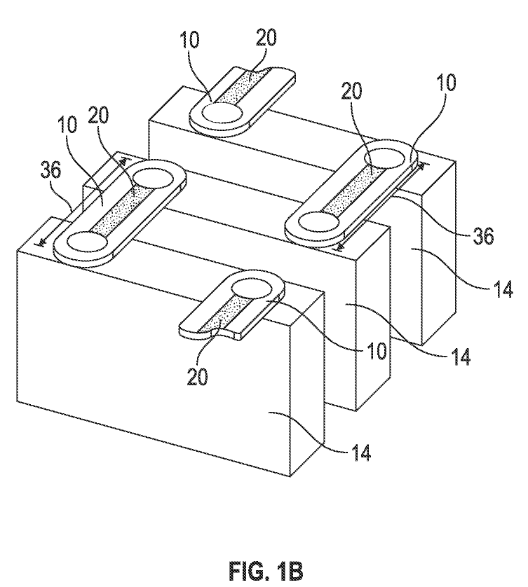

Referring to FIG. 1A, a plurality of busbars 10 disposed within a vehicle 12 is illustrated. The vehicle 12 includes a plurality of battery cells 14 and a motor 18. The plurality of battery cells may be, but not limited to, prismatic battery cells, cylindrical cells, or pouch battery cells. The plurality of battery cells 14 provide electrical energy to the motor 18. The plurality of busbars 10 is connected to the plurality of battery cells 14 and conducts the electrical energy of the plurality of battery cells 14, transferring the energy to the motor 18. The plurality of busbars 10 may be connected to the plurality of battery cells 14 by the use of wire bonding, laser welding, or other bonding or welding processes.

It is to be appreciated that FIG. 1A is merely exemplary in nature, and the plurality of busbars 10 are not limited to being employed for power distribution in a vehicle. Indeed, the plurality of busbars 10 may be used in a variety of other electromobility and stationary applications. It is also to be appreciated that the vehicle 12 may be any type of vehicle such as, but not limited to, a sedan, a truck, sport utility vehicle, van, or motor home.

Referring to FIG. 1B, an enlarged view of the plurality of busbars 10 connected to the plurality of battery cells 14 is illustrated. The plurality of busbars 10 may be in a series connection. The series connection adds voltage from each of the plurality of battery cells 14, ensuring the overall voltage for the vehicle 12 to operate is being received at the motor 18 (shown in FIG. 1A). The overall voltage for a hybrid electric vehicle to operate is between 100 and 200 volts (V). The overall voltage for an electric vehicle to operate is between 400 and 800 V.

The ability of the plurality of busbars 10 to transfer electrical power from the plurality of battery cells 14 to the motor 18 depends on the composition of the plurality of busbars 10. The plurality of busbars 10 is composed of at least a first copper (Cu) coil 20 and an aluminum (Al) body 22. The first Cu coil 20 has high electrical conductivity, causing efficient transfer of electrical energy with minimal electrical energy loss. The high electrical conductivity of the first Cu coil 20 also allows for effective heat dissipation, reducing the risk of overheating in the plurality of battery cells 14. The first Cu coil 20 is durable and resistant to mechanical wear and tear. The Al body 22 has lower conductivity and durability than the first Cu coil 20 but has a lighter weight than the first Cu coil 20. Combining the two metals allows for the busbar to maintain the benefits of the first Cu coil 20 and creates a reduction in mass of the plurality of battery cells 14.

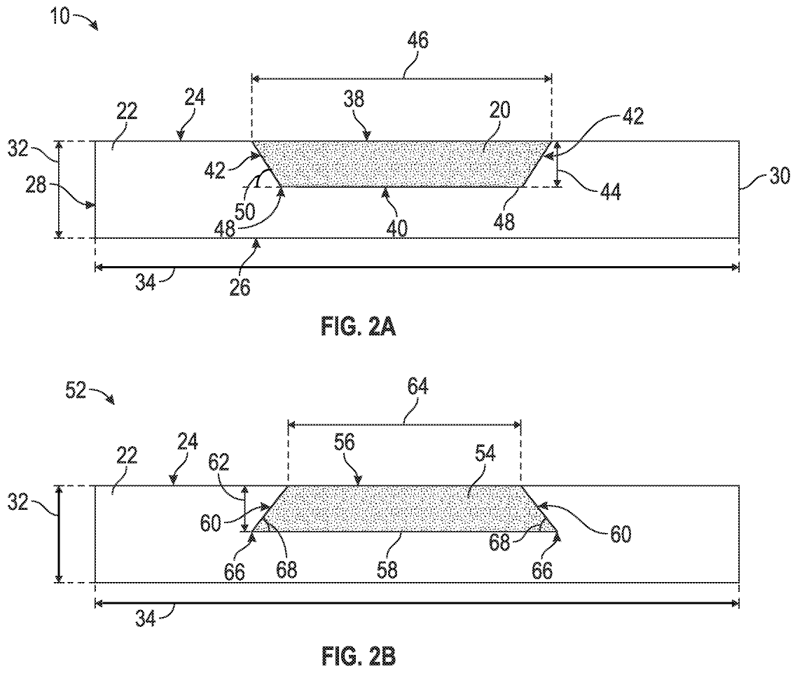

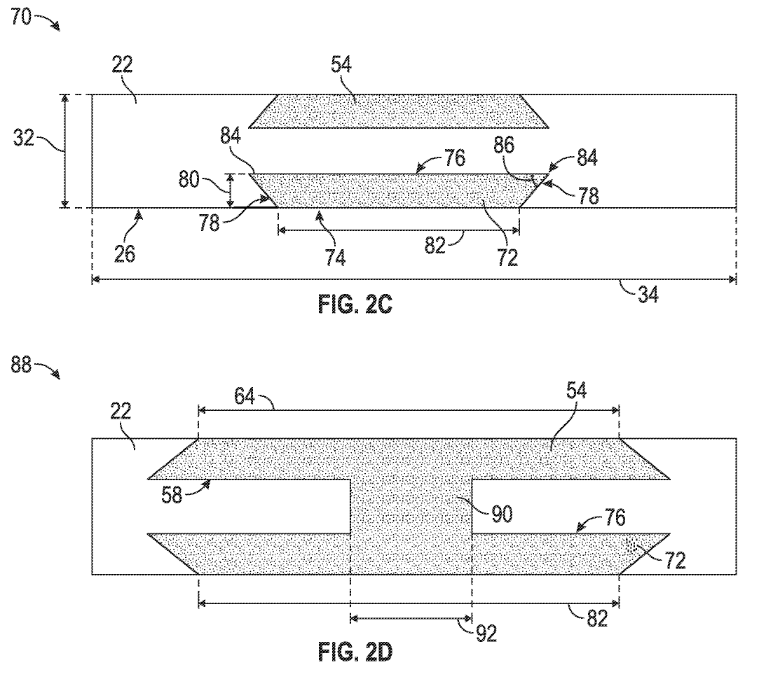

Referring to FIG. 2A, a cross-section view of one of the plurality of busbars 10 is illustrated. It should be appreciated that each of the plurality of busbars 10 is identical, and therefore only one of the busbars 10 will be described herein. The busbar 10 is formed by the first Cu coil 20 embedded within the Al body 22. The Al body 22 has an upper surface 24, a lower surface 26, a left surface 28, and a right surface 30. The upper surface 24 opposes the lower surface 26, defining an Al thickness 32. The left surface 28 opposes the right surface 30, defining an Al width 34. The left surface 28 and the right surface 30 are positioned between and connected to the upper surface 24 and the lower surface 26. The Al body 22 further includes a longitudinal length 36 (shown in FIG. 1B) in which the upper surface 24, the lower surface 26, the left surface 28, and the right surface 30 extend. The first Cu coil 20 is embedded within the Al body 22 and extends along the longitudinal length 36 (shown in FIG. 1B).

The first Cu coil 20 may be cut to a first desired shape 37 having a first outer surface 38, a first inner surface 40, and a first set of side surfaces 42. The first outer surface 38 is flush with the upper surface 24 of the Al body 22. The first inner surface 40 opposes the first outer surface 38, defining a first Cu thickness 44. The first Cu thickness 44 is between 5% and 30% of the Al thickness 32. The first set of side surfaces 42 define a first Cu width 46 and the first Cu width 46 is less than the Al width 34. The first set of side surfaces 42 are positioned between and connect to the first outer surface 38 and the first inner surface 40, defining a first Cu width 46. The connection of the first set of side surfaces 42 to the first inner surface 40 defines a first set of edges 48. The first set of edges 48 defines a first angle 50, changing the first Cu width 46 while traveling from the first inner surface 40 towards the first outer surface 38. The first angle 50 is between 20 and 70 degrees, causing the first Cu width 46 to increase while moving from the first inner surface 40 towards the first outer surface 38.

Referring to FIG. 2B, a cross-section of an alternate busbar 10, indicated by reference number 52, is illustrated. The busbar 52 includes the Al body 22 shown in FIG. 2A. The busbar 52 further includes a first Cu coil 54. The first Cu coil 54 may be cut to a first desired shape 55 having a first outer surface 56, a first inner surface 58, and a first set of side surfaces 60. The first outer surface 56 is flush with the upper surface 24 of the Al body 22. The first inner surface 58 opposes the first outer surface 38, defining a first Cu thickness 62. The first Cu thickness 62 is between 5% and 30% of the Al thickness 32. The first set of side surfaces 60 defines a first Cu width 64 and the first Cu width 64 is less than the Al width 34. The first set of side surfaces are connected to and positioned between the first outer surface 56 and the first inner surface 58. The connection of the first set of side surfaces 60 to the first inner surface 58 defines a first set of edges 66. The first set of edges 66 defines a first angle 68, changing the first Cu width 64 while traveling from the first inner surface 58 towards the first outer surface 56. The first angle 68 is between 20 and 70 degrees, causing the first Cu width 64 to decrease while moving from the first inner surface 58 towards the first outer surface 56.

Referring to FIG. 2C, a cross-section view of an alternate busbar 52, indicated by reference number 70, is illustrated. The busbar 70 includes the Al body 22 and the first Cu coil 54 shown in FIG. 2B. The busbar 70 further includes a second Cu coil 72. The second Cu coil 72 may be cut to a second desired shape 73 having a second outer surface 74, a second inner surface 76, and a second set of side surfaces 78. The second outer surface 74 is flush with the lower surface 26 of the Al body 22. The second inner surface 76 opposes the second outer surface 74, defining a second Cu thickness 80. The second Cu thickness 80 is between 5% and 30% of the Al thickness 32. The second set of side surfaces 78 are positioned between and connect to the second outer surface 74 and the second inner surface 76, defining a second Cu width 82. The second Cu width 82 is less than the Al width 34. The connection between the second set of side surfaces 78 and the second inner surface 76 defines a second set of edges 84. The second set of edges 84 defines a second angle 86, changing the second Cu width 82 while traveling from the second inner surface 76 towards the second outer surface 74. The second angle 86 is between 20 and 70 degrees, causing the second Cu width 82 to decrease while moving from the second inner surface 76 to the second outer surface 74.

Referring to FIG. 2D, a cross-section view of an alternate embodiment of the busbar 70, indicated with reference number 88, is illustrated. The busbar 88 includes the Al body 22, the first Cu coil 54, and the second Cu coil 72 shown in FIG. 2C. The busbar 88 further includes a middle Cu portion 90. The middle Cu portion 90 connects to the first inner surface 58 of the first Cu coil 54 and the second inner surface 76 of the second Cu coil 72. The middle Cu portion 90 defines a middle width 92. The middle width 92 is less than the first Cu width 64 and the second Cu width 82.

FIGS. 2A-2D illustrate the busbar 10, 52, 70, and 88 with an interlock Cu-Al design. The interlock design is created by embedding the first Cu coil 20, 54 into the Al body 22. The second Cu coil 72 may also be embedded into the Al body 22. The first angle 50, 68 of the first Cu coil 20, 54 and the second angle 86 of the second Cu coil 72 enhances the bonding between the Al body 22 and the first Cu coil 20, 54, strengthening and improving reliability of the busbar 10, 52, 70, and 88. Additionally, while the busbar 10, 52, 70, and 88 undergoes working conditions, the first angle 50, 68 and the second angle 86 drive a more uniform thermal expansion.

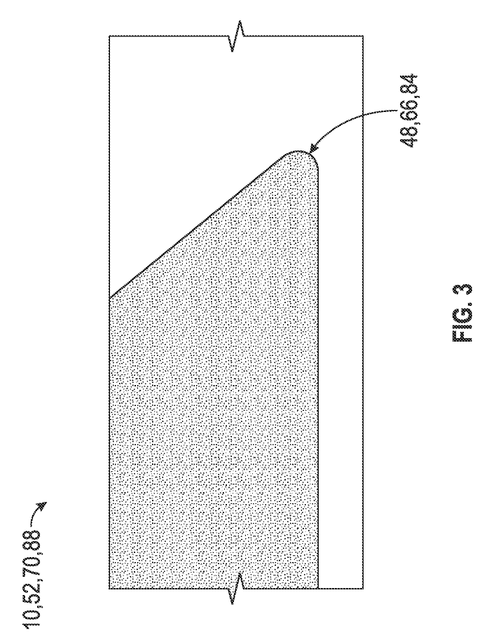

Referring to FIG. 3, an enlarged cross-section view of the busbar 10, 52, 70, and 88 is illustrated. The first set of edges 48, 66 and the second set of edges 84 may be tapered, having a radius between 0.05 and 0.5 millimeters (mm). The tapered first set of edges 48, 66 and the tapered second set of edges 84 avoids stress concentration, preventing cracking.

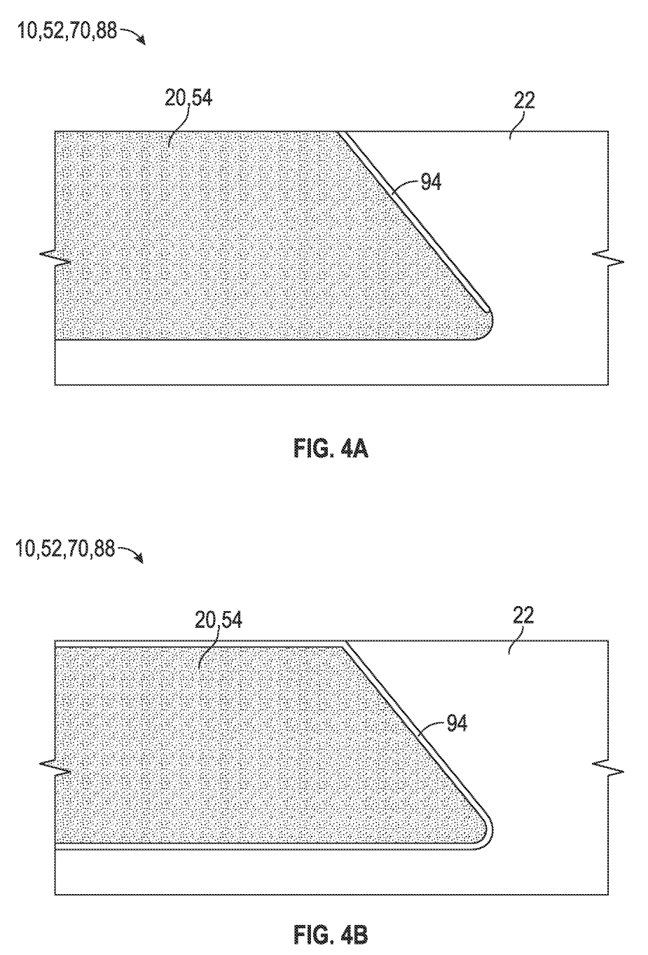

Referring to FIGS. 4A and 4B, an enlarged cross-section view of the busbar 10, 52, 70, and 88 with a coating 94 is illustrated. FIG. 4A illustrates the coating 94 covering a portion of a perimeter of the first Cu coil 20, 54. The coating 94 may also be applied to cover a portion of a perimeter of the second Cu coil 72 (not shown). Alternatively, FIG. 4B illustrates the coating 94 covering the perimeter of the first Cu coil 20, 54. The coating 94 may also be applied to cover the perimeter of the second Cu coil 72 (not shown). The coating 94 may be, but is not limited to tin (Sn), nickel (Ni), or silver (Ag). The coating 94 covering at least a portion of the perimeter of the first Cu coil 20, 54 and/or at least a portion of the second Cu coil 72 aids in avoiding intermetallic growth and enables better bonding with the first Cu coil 20, 54 and the Al body 22 and with the second Cu coil 72 and the Al body 22.

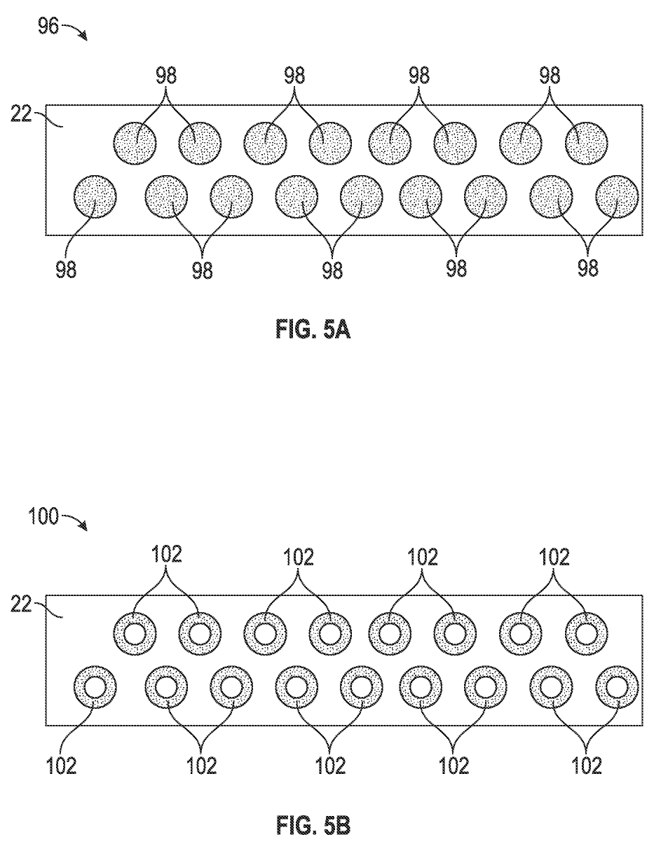

Referring to FIG. 5A, a cross-section view of an alternate busbar 10, indicated with reference number 96, is illustrated. The busbar 96 includes the Al body 22 shown in FIG. 2A. The busbar 96 further includes a first Cu coil 98. The first Cu coil 98 is formed of a plurality of pultruded copper. The first Cu coil 98 is disposed uniformly within the Al body 22, strengthening and improving reliability of the busbar 96. It is to be appreciated that FIG. 5A is merely exemplary in nature, and the first Cu coil 98 is not limited to having a circular cross section. The first Cu coil 98 may have a non-circular cross section.

Referring to FIG. 5B, a cross-section view of an alternate busbar 96, indicated with reference number 100, is illustrated. The busbar 100 includes the Al body 22 shown in FIG. 5A. The busbar 100 further includes a first Cu coil 102. The first Cu coil 102 is formed of a plurality of pultruded copper. The first Cu coil 102 is hollow and is disposed uniformly within the Al body 22, strengthening and improving reliability of the busbar 100. It is to be appreciated that FIG. 5B is merely exemplary in nature, and the first Cu coil 102 is not limited to having a circular cross section. The first Cu coil 102 may have a non-circular cross section.

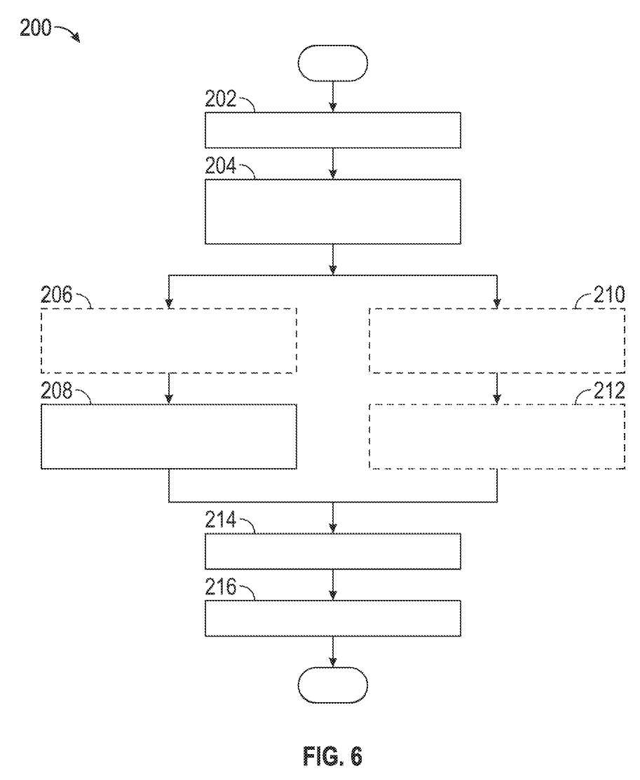

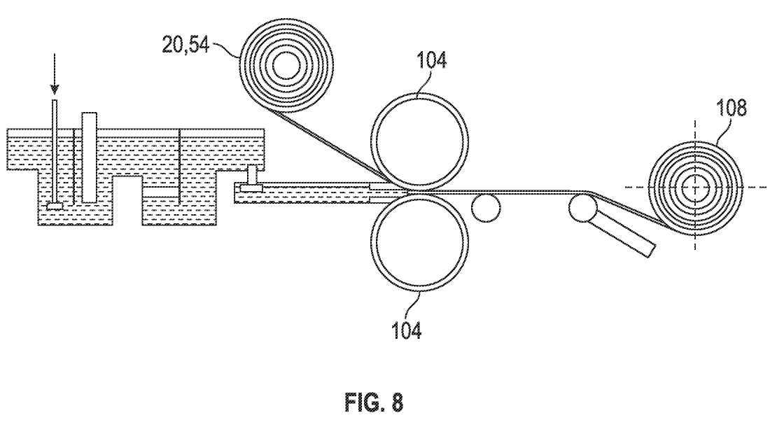

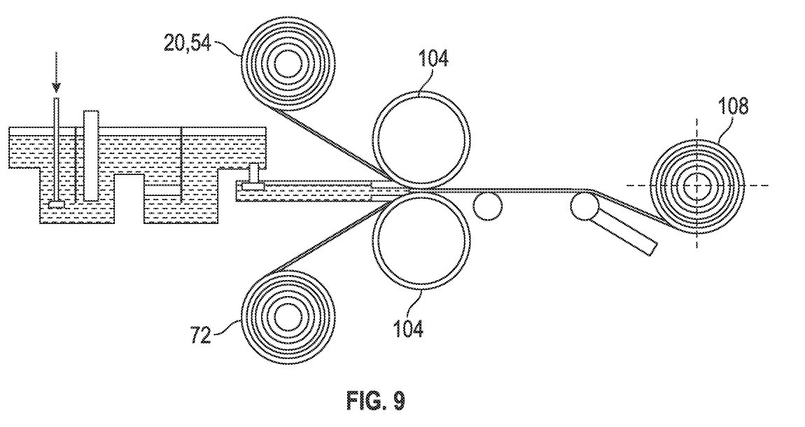

Referring to FIGS. 6, 8, and 9,6 , is a flow chart for a method 200 of creating the busbar 10, 52, 70, 88, 96, and 100 and FIGS. 8 and 9 are diagrams illustrating the method 200. The method 200 begins with step 202. At step 202, the Al body 22 is heated to create a liquid Al. At step 204, the liquid Al is channeled to water cooled rollers 104.

At step 206, the first Cu coil 20, 54 may be cut to the first desired shape 37, 55. At step 208, the first Cu coil 20, 54 is fed between the water cooled rollers 104, coming in contact with the upper surface 24 of the liquid Al. The water cooled rollers 104 apply a pressure to the first outer surface 38, 56 of the first Cu coil 20, 54 and to the upper surface 24 of the liquid Al. The pressure against the first Cu coil 20, 54 embeds the first Cu coil 20, 54 into the liquid Al.

At step 210, the second Cu coil 72 may be cut to the second desired shape 73. At step 212, the cut second Cu coil 72 may be fed between the water cooled rollers 104 simultaneously with the first Cu coil 20, 54. The second Cu coil 72 comes in contact with the lower surface 26 of the liquid Al. The water cooled rollers applies a pressure to the second outer surface 74 of the second Cu coil 72 and to the lower surface 26 of the liquid Al. The pressure against the second Cu coil 72 embeds the second Cu coil 72 into the liquid Al.

At step 214, the liquid Al is cooled by the water cooled rollers 104. Cooling the liquid Al causes the liquid Al to become solid, bonding the solid Al with the embedded first Cu coil 20, 54. If the second Cu coil 72 is embedded into the liquid Al prior to cooling, the cooling of the liquid Al bonds the solid Al with the embedded second Cu coil 72. At step 216, a tension coil 106 is created with the solid Al and the bonded first Cu coil 20, 54. If the second Cu coil 72 is embedded into the liquid Al, the tension coil 106 is created with the solid Al, the bonded first Cu coil 20, 54 and the bonded second Cu coil 72. The busbar 10, 52, 70, 88, 96, and 100 is created from the tension coil 106.

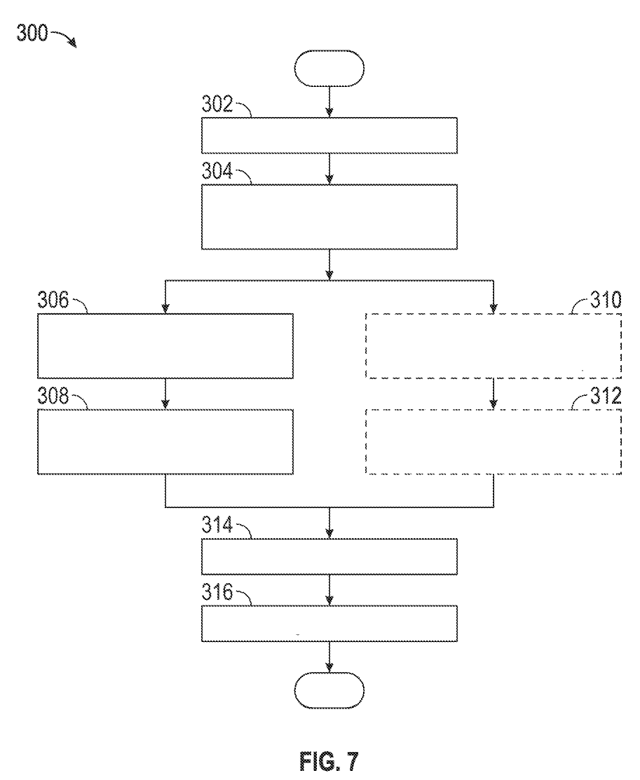

Referring to FIGS. 7, 8, and 9,7, is a flow chart for a method 300 of creating the busbar 10, 52, 70, and 88 and FIGS. 8 and 9 are diagrams illustrating the method 300. The method 300 begins with step 302. At step 302, the Al body 22 is heated to create a liquid Al. At step 304, the liquid Al is channeled to water cooled rollers 104.

At step 306, the first Cu coil 20, 54 is cut to the first desired shape 37, 55. At step 308, the cut first Cu coil 20, 54 is fed between the water cooled rollers 104, coming in contact with the upper surface 24 of the liquid Al. The water cooled rollers 104 apply a pressure to the first outer surface 38, 56 of the cut first Cu coil 20, 54 and to the upper surface 24 of the liquid Al. The pressure applied to the cut first Cu coil 20, 54 is partially perpendicular due to the first angle 50, 68 of the first set of side surfaces 42, 60. The partially perpendicular pressure against the cut first Cu coil 20, 50 embeds the cut first Cu coil 20, 54 into the liquid Al and creates reliable bonding under in-service thermal expansion.

At step 310, the second Cu coil 72 may be cut to the second desired shape 73. At step 312, the cut second Cu 72 coil may be fed between the water cooled rollers 104 simultaneously with the cut first Cu coil 20, 54. The cut second Cu coil 72 comes in contact with the lower surface 26 of the liquid Al. The water cooled rollers 104 applies a pressure to the second outer surface 74 of the cut second Cu coil 72 and to the lower surface 26 of the liquid Al. The pressure applied to the cut second Cu coil 72 is partially perpendicular due to the second angle 86 of the second of side surfaces 78. The partially perpendicular pressure against the cut second Cu coil 72 embeds the cut second Cu coil 72 into the liquid Al and creates reliable bonding under in-service thermal expansion.

At step 314, the liquid Al is cooled by the water cooled rollers 104. Cooling the liquid Al causes the liquid Al to becomes solid, bonding the solid Al with the embedded cut first Cu coil 20, 54. If the cut second Cu coil 72 is embedded into the liquid Al prior to cooling, the cooling of the liquid Al bonds the solid Al with the embedded cut second Cu coil 72. At step 316, the tension coil 106 is created with the solid Al and the bonded cut first Cu coil 20, 54. If the cut second Cu coil 72 is embedded into the liquid Al, the tension coil 106 is created with the solid Al, the bonded cut first Cu coil 20, 54 and the bonded cut second Cu coil 72. The busbar 10, 52, 70, and 88 is created with the tension coil 106.

The busbar 10, 52, 70, 88, 96, and 100 of the present disclosure offers several advantages. These include strengthening and improving reliability of the busbar while reducing mass of the plurality of battery cells 14. Additionally, the first desired shape 37, 55 of the first Cu coil 20, 54 and the second desired shape 73 of the second Cu coil 72 enhances the bonding with the Al body 22, driving a more uniform thermal expansion.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A busbar with an interlock interface, the busbar comprising:
an aluminum (Al) body including an upper surface and a lower surface opposing the upper surface; and
a first copper (Cu) coil embedded within the Al body, the first Cu coil including:
a first outer surface flush with the upper surface of the Al body;
a first inner surface opposing the first outer surface;
a first set of side surfaces positioned between and connected to the first outer surface and the first inner surface; and
a first edge formed by the connection of the first set of side surfaces and the first inner surface, wherein the first edge defines a first angle between 20 and 70 degrees.

2. The busbar of claim 1, wherein the first edge is tapered.

3. The busbar of claim 1, wherein at least a portion of a perimeter of the first Cu coil is coated with one of the following: tin (Sn), nickel (Ni), and silver (Ag).

4. The busbar of claim 1, wherein the first set of side surfaces defines a first width increasing from the first inner surface towards the first outer surface.

5. The busbar of claim 1, wherein the first set of side surfaces defines a first width decreasing from the first inner surface towards the first outer surface.

6. The busbar of claim 5, further comprising a second Cu coil embedded within the Al body, the second Cu coil including:
a second outer surface flush with the lower surface of the Al body;
a second inner surface opposing the second outer surface;
a second set of side surfaces positioned between and connected to the second outer surface and the second inner surface, wherein the second set of side surfaces defines a second width decreasing from the second inner surface towards the second outer surface; and
a second edge formed by the connection of the second set of side surfaces and the second inner surface, wherein the second edge defines a second angle between 20 and 70 degrees.

7. The busbar of claim 6, wherein the first edge of the first Cu coil and the second edge of the second Cu coil are tapered.

8. The busbar of claim 6, further comprising a middle Cu portion, wherein the middle Cu portion is positioned between the first Cu coil and the second Cu coil, connecting the first Cu coil to the second Cu coil.

9. A method of forming a busbar comprising:
heating an aluminum (Al) body to form liquid Al;
channeling the liquid Al to water cooled rollers;
feeding a first copper (Cu) coil between the water cooled rollers, wherein the first Cu coil is in contact with an upper surface of the liquid Al, wherein the water cooled rollers apply pressure against the first Cu coil and the liquid Al, and wherein the pressure embeds the first Cu coil within the liquid Al;
cooling the liquid Al with the water cooled rollers, solidifying the liquid Al and bonding the first Cu coil to the solid Al; and
creating a tensioned coil with the solid Al and the first Cu coil, forming the busbar.

10. The method of claim 9, further comprising cutting the first Cu coil to a first desired shape prior to feeding the first Cu coil between the water cooled rollers, the first desired shape including:
a first outer surface flush with the upper surface of the Al;
a first inner surface opposing the first outer surface; and
a first set of side surfaces, wherein the first set of side surfaces defines a first angle, and wherein the first angle is between 20 and 70 degrees.

11. The method of claim 10, wherein the first desired shape defines a first width increasing from the first inner surface towards the first outer surface.

12. The method of claim 10, wherein the first desired shape defines a first width decreasing from the first inner surface towards the first outer surface.

13. The method of claim 10, further comprising cutting a second Cu coil to a second desired shape, the second desired shape including:
a second outer surface flush with a lower surface of the Al;
a second inner surface opposing the second outer surface; and
a second set of side surfaces, wherein the second set of side surfaces defines a second angle, and wherein the second angle is between 20 and 70 degrees; and
feeding the cut second Cu coil between the water cooled rollers, wherein the cut second Cu coil is in contact with a lower surface of the liquid Al, wherein the water cooled rollers apply pressure against the cut second Cu coil and the liquid Al, wherein the pressure embeds the cut second Cu coil within the liquid Al, and wherein the water cooled rollers solidify the liquid Al, bonding the cut second Cu coil to the solid Al.

14. The method of claim 13, wherein the first desired shape defines a first width decreasing from the first inner surface towards the first outer surface and wherein the second desired shape defines a second width decreasing from the second inner surface towards the second outer surface.

15. The method of claim 9, wherein the first Cu coil is a plurality of pultruded copper.

16. The method of claim 15, wherein the plurality of pultruded copper is hollow.

17. A method of forming a busbar comprising:
heating an aluminum (Al) body to form liquid Al;
channeling the liquid Al to water cooled rollers;
cutting a first copper (Cu) coil to a first desired shape, wherein the first desired shape includes a first outer surface, a first inner surface, and a first set of side surfaces, wherein the first set of side surfaces defines a first angle, and wherein the first angle is between 20 and 70 degrees;
feeding the cut first Cu coil between the water cooled rollers, wherein the cut first Cu coil is in contact with an upper surface of the liquid Al, wherein the water cooled rollers apply a pressure against the cut first Cu coil and the liquid Al, and wherein the pressure embeds the cut first Cu coil within the liquid Al;
cooling the liquid Al with the water cooled rollers, solidifying the liquid Al and bonding the cut first Cu coil to the solid Al; and
creating a tensioned coil with the solid Al and the cut first Cu coil, forming the busbar.

18. The method of claim 17, wherein the first desired shape defines a first width increasing from the first inner surface towards the first outer surface.

19. The method of claim 17, wherein the first desired shape defines a first width decreasing from the first inner surface towards the first outer surface.

20. The method of claim 19, further comprising cutting a second Cu coil to a second desired shape, the second desired shape including:
a second outer surface flush with a lower surface of the Al;
a second inner surface opposing the second outer surface; and
a second set of side surfaces, wherein the second set of side surfaces defines a second angle between 20 and 70 degrees, and wherein the second desired shape defines a second width decreasing from the second inner surface towards the second outer surface; and
feeding the cut second Cu coil between the water cooled rollers, wherein the cut second Cu coil is in contact with the lower surface of the liquid Al, wherein the water cooled rollers apply a pressure against the cut second Cu coil and the liquid Al, wherein the pressure embeds the cut second Cu coil within the liquid Al, wherein the water cooled rollers solidify the liquid Al, bonding the cut second Cu coil to the solid Al.
